(19) United States
(12) Patent Application Publication
(10) Pub. No.: US 2007/0227794 A1
(43) Pub. Date: Oct. 4, 2007

(54) DEVICE WHICH IS DESIGNED TO BE ARRANGED AS AN ADDITIONAL PART BEHIND A RADIATOR GRILLE IN AN ENGINE COMPARTMENT OF A MOTOR VEHICLE

(76) Inventor: Peter DIEHL, Kirchheim (DE)

Correspondence Address: MAGNA INTERNATIONAL, INC., 337 MAGNA DRIVE, AURORA, ON, L4G-7K1, US

(21) Appl. No.: 11/695,813

(22) Filed: Apr. 3, 2007

(30) Foreign Application Priority Data
Apr. 4, 2006 (DE) 102006016880.1

(51) Int. Cl. B60K 11/04

(52) U.S. Cl. 180/68.4

(57) ABSTRACT

The device according to the invention is designed so as to be arranged as an additional part behind a radiator grille in an engine compartment of a motor vehicle. The device has a substantially planar base body, this base body comprising a plurality of openings and at least one closure plate, wherein the at least one closure plate is movably arranged via at least one securement element on the base body in such a way as to be able to close at least one of the openings.

### CROSS-REFERENCE TO RELATED APPLICATIONS

This application claims the benefit of German Patent Application Serial No. 102006016880.1, filed on Apr. 4, 2006 and entitled “Einrichtung, die dazu ausgebildet ist, als Zusatzteil hinter einem Kühlergitter in einem Motorraum eines Kraftfahrzeugs angeordnet zu warden” (“Device which is designed to be arranged as an additional part behind a radiator grille in an engine compartment of a motor vehicle”).

### FIELD OF THE INVENTION

The present invention generally relates to a device which is designed to be arranged as an additional part behind a radiator grille in an engine compartment of a motor vehicle and such a radiator grille.

### BACKGROUND OF THE INVENTION

Against the background of the so-called EURO4 exhaust emissions regulation a cold-running phase of a motor vehicle is included in its classification in a pollutant category. The sooner the vehicle reaches its operating temperature the lower are its pollutant emissions, which is beneficial as regards the classification, so that the vehicle is classified more favourably for taxation purposes.

It is known that vehicles with closable radiator grilles reach the operating temperature more quickly in the cold-running phase than vehicles in which the radiator grilles cannot be closed.

Closable motor vehicle radiator grille units can be realised for example if cold air inlets of a radiator grille can be closed by means of plates or the like

arranged behind the radiator grille. A closure of the cold air inlets of the radiator grille can lead to an improvement of the cw value and furthermore can better adapt the amount of inflowing cold air to an operating state of the vehicle.

A closable radiator grille for motor vehicles is known from DE 200 21 023 U1 Here, louvre plates are arranged behind the immovable radiator grille, which plates can be deflected transversely to the outflow direction in order to close gaps, i.e. cold air inlets in the radiator grille. The installation of the louvre plates as well as their design itself, with rigid zones and non-rigid zones provided therebetween, is however complicated and expensive.

A control arrangement for movable parts of a radiator grille is known from DE 39 16 907 A1. Here the radiator grille comprises movable parts in the form of plates that can swivel transversely to the flow direction and which, depending on the operating state of the vehicle, can be moved from an open state to a closed position, in which they run substantially perpendicular. Also, with this radiator grille the closability is provided for respective individual adjustable plates. The installation of the plates is however complicated and subject to problems.

Furthermore it is known to provide a cooling unit of a vehicle with a closable attachment, wherein this attachment is closed during the cold-running phase and is then opened by a dynamic pressure of a flow and/or by an aspiration action of a radiator fan.

In this connection reference may be made to DE 102 39 879 A1, in which a method is described for reducing the air resistance of a vehicle with a fan, which is provided in particular for cooling an internal combustion engine by conveying an air stream from the surrounding atmosphere into the vehicle engine compartment. In this case a reversal of the direction of rotation and/or a shut-down of the fan is carried out by means of an electromagnet, which requires a complicated electromagnetic control arrangement.

EP 1 362 732 A1 describes a device for actuating at least one control valve for controlling an air stream in a vehicle by means of an actuator comprising a shape memory alloy. This device is for example provided so as to control a cold air stream in a front region of the vehicle by means of the at least one control valve.

Against the background of the prior art it would now be desirable to provide a simple and efficient device that as far as possible does not detract from the outward appearance of a radiator grille, and by means of which the said radiator grille can be closed.

### SUMMARY OF THE INVENTION

On the basis of the above a device is proposed having the features of claim 1 and a radiator grille is proposed having the features of claim 20.

The device according to the invention is designed so as to be arranged as an additional part behind a radiator grille in an engine compartment of a vehicle. The device includes a substantially planar base body, this base body comprising a plurality of openings and at least one closure plate, wherein the at least one closure plate is movably arranged via at least one securement element on the base body so as to be able to close at least one of the openings.

This device can be manufactured easily and inexpensively irrespective of the shape of the radiator grille or the radiator grille itself. A boundary or contour of the largely two-dimensional and planar or flat base body should match a projection of the radiator grille in the direction of movement of the vehicle. Base bodies matching the respective projections can be used in a modular fashion for a plurality of different radiator grilles for various models and marques of vehicles. A three-dimensional shape of the radiator grille does not have to be taken into account in the design of the contour of the base body. Furthermore it is also possible to add a device according to the invention having a correspondingly suitably shaped base body to the engine compartment of a vehicle in retrospect. The at least one closure plate is integrated via the at least one securement element in the device.

The base body of this device may thus be designed to be compact and with thin walls. In an installed state this base body may have a small width or thickness in the direction of movement of the vehicle.

As a rule all openings of the base body can be closed with a closure plate provided for this purpose. Each opening may in this connection be closed for example by in each case a closure plate provided for this opening. The number of closure plates is typically equal to the number of openings.

Furthermore the base body in plan view, on the basis of the projection in the direction of movement, is designed to be flat. In this connection the base body is interrupted structurally at least one opening, normally at several openings, so that the openings form recesses within the base body. At least one section of the base body in each case encloses or delimits an opening at least partially, and as a rule completely. Thus, such a section of the base body is arranged between in each case two openings.

So that the closure plates can close as well as open the openings of the base body of the device, a closable radiator grille is provided with this device in combination with the spaced-apart radiator grille. It is thus possible to regulate and direct an air stream to an engine arranged in an engine compartment of a vehicle. The openings of the device should preferably be closed during a cold-running or warm-up phase of the vehicle, thereby regulating the cold air flow, so that only a regulated amount of cold air flows via the radiator grille into the engine compartment and to the engine. On account of this the engine can reach its operating temperature in a shorter time than usual, resulting in a reduction of the pollutant emissions from the engine.

The device which can be arranged or is to be arranged behind the radiator grille may be secured to the radiator grille at a specific distance therefrom. The device provided as an additional part for the radiator grille is thus firmly connected to the said radiator grille. Alternatively it is also possible to secure the device provided as an additional part to another component suitable for this purpose within the engine compartment of the corresponding vehicle, in such a way that the said device is arranged at the specific distance behind the radiator grille.

The distance may in this connection advantageously be chosen so that the device according to the invention cannot be seen when looking at the radiator grille from the front, and therefore does not detract from the outer appearance of the radiator grille.

The largely two-dimensionally designed planar base body may have only a small thickness, which is just sufficient to ensure the necessary stability of the device.

On account of the flat design of the base body this and thus also the device are simple to manufacture. It is for example conceivable to cut out at least one base body from a large flat section and optionally to provide it with the at least one opening in the same work stage. On a mass production scale, when cutting out the at least one base body its contour and/or circumference can easily be matched to an envisaged use and thus to a projection of a corresponding radiator grille, so that its contour corresponds largely to the projection or a shadow outline of the radiator grille behind which the base body and thus the device are to be arranged within the engine compartment. Accordingly the device can also be used as an additional part for curved radiator grilles, since in this case only the projection of the radiator grille has to be taken into account. It is not necessary for the base body of the present device to have the same profile as the radiator grille on which this device is to be arranged.

The at least one securement element for fastening the at least one closure plate to the base body is designed so that the at least one closure plate is movable via the securement element relative to the base body, and thereby at least one of the openings provided in the base body can be closed and if necessary can be opened. This is achieved for example if the at least one securement element has a suitable axis or rotation around which the at least one closure plate can move or rotate relative to the base body and to the at least one opening. The at least one securement element may for example be secured to an edge region of one of the openings, so that the at least one closure plate is movably secured via the at least one securement element to the edge region and thus directly to the at least one opening.

In a further modification it is envisaged that the at least one securement element is injection moulded on the base body. An injection moulding of the at least one securement element takes place after a forming and shaping of the base body and/or after this base body is provided with the at least one opening. Because the injection moulding or generally fastening of the at least one securement element to the base body takes place after the forming and shaping of the latter, the device can be individually and flexibly designed overall taking account of the projection of the radiator grille behind which the device is to be or should be arranged in an intended use.

It may also be envisaged that the at least one securement element is made of plastics material. In this case the base body and/or the closure plates may also be made of plastics material. Thereby, this at least one securement element can be made at least partially or completely of polypropylene and/or at least partially or completely of rubber. Any other suitable plastics material can however also be used. Apart from rubber and/or polypropylene the at least one securement element may also include as possible constituents further materials, in particular plastics materials.

In a production process the at least one closure plate can be integrated in a mould with the at least one injection moulded securement element. Cost savings for the production of the at least one closure plate and/or the assembly of the at least one closure plate on the base body are thereby achieved. The closure plates integrated in the base body of the device can thus easily be produced as regards tools technology.

To impart a mobility to the at least one closure plate relative to the base body, it may furthermore also be envisaged that the at least one securement element is designed as an elastically deformable, i.e. flexible or non-rigid plastics component, such as for example as a type of film hinge. Alternatively it is conceivable in this connection for the at least one securement element to be designed as a hinge.

It is envisaged that the at least one closure plate is integrated in the device and thus in the base body via the at least one securement element. In this connection the at least one closure plate is integrated in the device in such a way that this at least one closure plate in a first operating situation, preferably on start-up or during a cold-running phase of the engine, closes the at least one opening so that during this time the engine quickly reaches its ideal operating temperature. In a second operating situation, preferably when the engine has reached its operating temperature, it is envisaged that the at least one closure plate at least partly or completely opens the at least one opening in the base body, so that the engine within the engine compartment is supplied with air.

It may be envisaged that at least one closure plate, when this closes the at least one opening, forms a tight flush closure with at least one surface of the base body. In this connection the closure plate may have the same thickness as the base body, and thus the closure plate and the base body, when the said closure plate closes the at least one opening, can form the flush closure on a front side as well as on a rear side of the base body, whereby the closure plate is integrated and accommodated in the base body.

In the case where in each case an opening can be closed with a closure plate, it may be envisaged that an outer edge of the closure plate and an inner edge of the opening are largely coincident with one another. This means that when the closure plate closes the opening, then the closure plate and the at least one securement element, in each case depending on the shape of the latter, completely cover this opening, whereby the closure plate is similarly integrated in the base body.

In a third operating situation, preferably when the vehicle is running at high speed, the at least one opening in the base body may likewise be closed by the at least one closure plate. In this way it is possible at high vehicle speeds to improve the value for the air resistance and the cw value of the vehicle, respectively.

The present device may furthermore also comprise at least one actuator, which is fastened or coupled for example in the form of a linkage or a lever to the at least one closure plate, for example by injection moulding, so that the at least one closure plate can be moved via this actuator relative to the base body. In this connection the at least one closure plate may co-operate via the actuator with a suitable drive unit, the closure plate being connected by the actuator to the drive unit.

In a further embodiment a movement of the at least one closure plate can be controlled by the pressure generated by the air flowing through the radiator grille to the base body of the device when the vehicle is moving. In this case it may be envisaged that the at least one securement element permits a movement of the at least one closure plate, which closes the at least one opening of the base body, only when the air flowing through the radiator grille into the engine compartment exceeds a certain pressure that depends on the speed of the moving vehicle. A movement, dependent on the air pressure, of the at least one closure plate from a position that closes the at least one opening may be regulated in a complementary or alternative manner by the appropriately shaped actuator.

The invention moreover relates to a radiator grille on which the device according to the invention is secured as an additional part, in particular at a defined distance from a front side of the radiator grille. Accordingly this radiator grille comprises as an additional part the device together with a base body, this base body including a number of openings and at least one closure plate, wherein the at least one closure plate is movably arranged on the base body via at least one securement element so as to be able to close at least one of the openings. The device is arranged or secured on a side of the radiator grille facing towards or that can be turned towards an engine compartment of a corresponding vehicle, i.e. is arranged or secured on an inside of the radiator grille.

Further advantages and modifications of the invention follow from the description and the accompanying drawings.

It is understood that the aforementioned features and those still to be explained hereinafter can be employed not only in the combination specified in each case, but also in other combinations or individually, without departing from the scope of the present invention.

### BRIEF DESCRIPTION OF THE DRAWINGS

Exemplary embodiments of the invention will now be described in conjunction with the following drawings wherein like numerals represent like elements, and wherein:

FIG. 1 shows diagrammatically an embodiment of a radiator grille according to the invention together with an additional part;

FIG. 2 shows a section along a sectional line II-II of FIG. 1;

FIG. 3 shows diagrammatically a further possible configuration of a device according to the invention used as an additional part for a radiator grille;

FIG. 4 shows a front view of the additional part of FIG. 3; and

FIG. 5 shows a section through the additional part for the radiator grille of FIG. 3.

### DETAILED DESCRIPTION OF THE PREFERRED EMBODIMENTS

The figures are mutually consistent and are described contiguously and overall, the same reference numerals denoting the same structural parts.

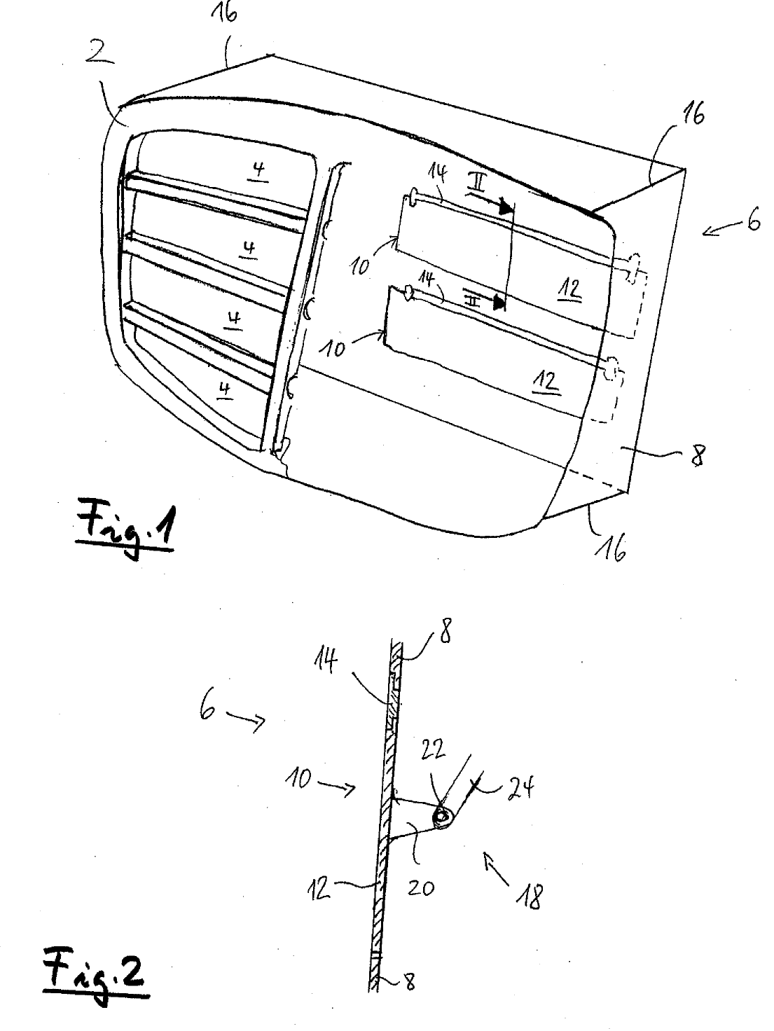

FIG. 1 shows diagrammatically in a partly exploded view a radiator grille 2 for a vehicle, which comprises a plurality of air passage openings or ventilation slits 4. Such a radiator grille 2 is normally arranged on a front region of the vehicle as a wall partition for an engine compartment. In particular when the vehicle is moving quickly air passes through the ventilation slits 4 and reaches an engine arranged in the engine compartment.

FIG. 1 also shows a device 6, which is arranged as an additional part behind the radiator grille 2 in the engine compartment of the vehicle. The device 6 comprises a base body 8, this base body 8 containing a number of openings 10, on the respective upper edge of which is arranged in each case a closure plate 12. In this connection a closure plate 12 is in each case movably arranged on the base body 8 via a securement element 14 so that the respective opening 10 can be closed by means of the closure plate 12. An outer edge of the closure plate 12 and an inner edge of the opening 10 are in this case virtually coincident. Accordingly a closure plate 12 with a corresponding securement element 14 can completely cover the corresponding opening 10. The securement elements 14 may be formed of an elastically deformable plastics material.

In the present embodiment the device 6 is secured via diagrammatically illustrated securement means 16 to the radiator grille 2. The base body 8 of the device 6 is in the present embodiment designed so as to be largely two-dimensional or planar, and thus has a substantially planar surface. A contour of the base body 8 of the device 6 is matched to a projection of the radiator grille 2 in the direction of movement of the vehicle and is thus correspondingly shaped in relation to its circumference. The base body 8 is thus designed independently of a three-dimensional shape of the radiator grille 2, in particular of its curvature.

FIG. 2 shows a section of FIG. 1 along the sectional line II-II. The base body 8 in the present FIG. 2 surrounds the opening 10, which in this case is closed by the closure plate 12. The closure plate 12 is connected via the securement element 14 on an edge region of the opening 10 to the base body 8 of the device 6. Also an articulated actuator 18 is fixed by injection moulding to the closure plate 12. This actuator 18 comprises a first arm 20, a rotational point 22 and an actuating rod 24. A relative movement between the actuating rod 24 and the arm 22 and thus the closure plate 12 is possible via the rotational point 22. The closure plate 12 may be moved via the actuator 18 relative to the base body 8, whereby the opening 10 can be both opened and closed. The closure plate 12 and the base body 8 have the same thickness, so that the closure plate 12 and the base body 8, when the closure plate 12 closes the opening 10, form a tight flush closure on a front side as well as on a rear side of the base body 8.

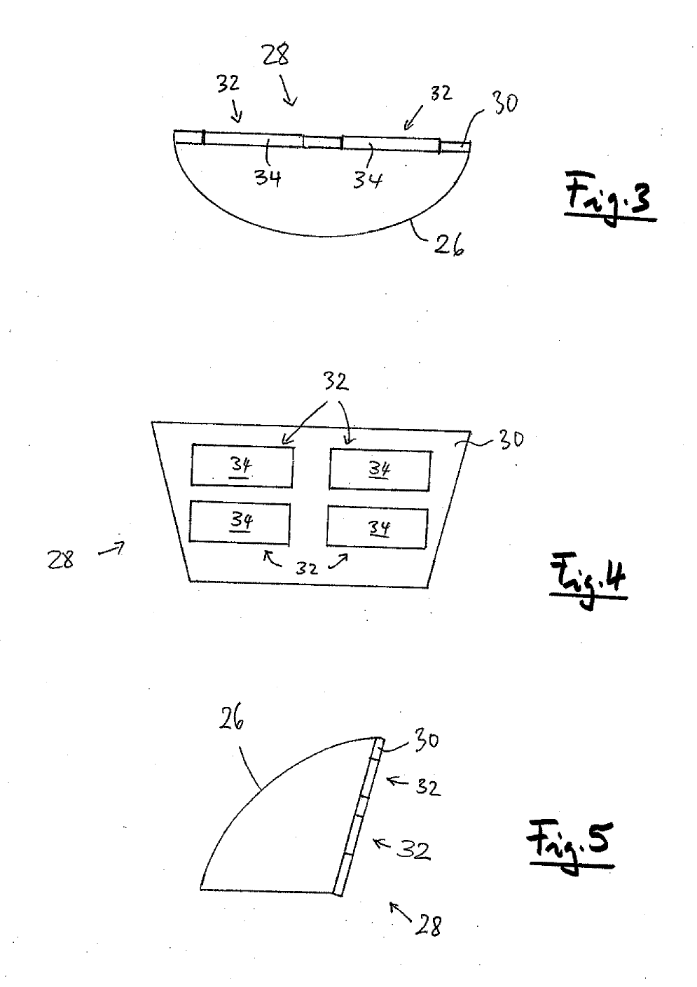

FIGS. 3, 4 and 5 show in each case diagrammatically a further embodiment of a device 28 according to the invention provided as an additional part for a radiator grille 26. The device 28 comprises a two-dimensional, flat base body 30 with openings 32. In the present FIGS. 3 to 5 these openings 32 are closed by closure plates 34, which are secured to the base body 30 by securement elements, not shown here, although the closure plates 34 can be moved via the securement elements relative to the base body, and the openings 32 can thus be at least partly opened.

The base body 30 of the device 28 is flat and two-dimensional and has planar surfaces, into which the closure plates 34 can be inserted in a largely seamless manner. The two-dimensional shape or contour of the device 28 and in particular of the base body 30 differs substantially from the three-dimensional shape of the radiator grille 26, which has a curvature. As FIG. 4 shows, a contour of the base body 30 is in the present embodiment trapezoidal and thus rectangular. The base body 30 can for example be easily cut out by suitable cutting processes from a larger flat part. When shaping and forming the base body care simply has to be taken to ensure that the contour of the base body preferably corresponds to a projection of the radiator grille 26 in the direction of movement of the vehicle. Such a device 30 provided as an additional part for the radiator grille 26 can thus be produced in a simple and modular manner.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed is:

1. A device which is designed to be arranged as an additional part behind a radiator grille in an engine compartment of a motor vehicle, and which includes a substantially planar base body, this base body comprising a plurality of openings and at least one closure plate, wherein the at least one closure plate is movably arranged via at least one securement element on the base body in such a way as to be able to close at least one of the openings.

2. The device according to claim 1, which is to be secured to the radiator grille.

3. The device according to claim 1, in which a contour of the base body corresponds to a projection of the radiator grille in the direction of movement of the motor vehicle.

4. The device according to claim 1, which is to be arranged at a specific distance from a front side of the radiator grille.

5. The device according to claim 1, in which the at least one securement element is designed so that the at least one closure plate can move via the securement element relative to the base body.

6. The device according to claim 1, in which the at least one securement element comprises an axis of rotation.

7. The device according to claim 1, in which the at least one closure plate is movably secured via the at least one securement element to an edge region of one of the openings.

8. The device according to claim 1, on which the at least one securement element is injection moulded at least partly onto the base body.

9. The device according to claim 1, in which the at least one securement element is formed at least partly of plastics material.

10. The device according to claim 1, in which the at least one securement element is formed at least partly of polypropylene.

11. The device according to claim 1, in which the at least one securement element is formed at least partly of rubber.

12. The device according to claim 1, in which the at least one securement element is formed as an elastically deformable plastics component.

13. The device according to claim 1, in which the at least one securement element is formed as a film hinge.

14. The device according to claim 1, in which the at least one securement element is formed as a hinge.

15. The device according to claim 1, in which the at least one closure plate is integrated in such a way that this at least one closure plate in a first operating situation closes the at least one opening, and that the at least one closure plate in a second operating situation at least partly opens the at least one opening.

16. The device according to claim 15, in which the at least one closure plate, when this closes the at least one opening, forms a tight flush closure with at least one surface of the base body.

17. The device according to claim 15, in which an actuator is secured to the at least one closure plate, wherein the at least one closure plate can be moved via this actuator relative to the base body.

18. The device according to claim 15, in which the at least one closure plate can be mechanically moved.

19. The device according to claim 15, in which the at least one closure plate can be moved by means of a pressure of flowing air.

20. A radiator grille, on which a device according to claim 1 is secured as an additional part.
